(19) United States
(12) Patent Application Publication
(10) Pub. No.: US 2014/0254985 A1
(43) Pub. Date: Sep. 11, 2014

(54) OPTICAL CONNECTOR AND METHOD FOR ASSEMBLING SAME

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 14/022,245

(22) Filed: Sep. 10, 2013

(30) Foreign Application Priority Data
Mar. 6, 2013 (TW) 102107747

(51) Int. Cl. G02B 6/42

(52) U.S. Cl. CPC G02B 6/4204
USPC 385/33; 156/305

(57) ABSTRACT

An optical connector includes a substrate, an optical emitter, an optical receiver, a support member, and a lens member. The optical emitter and the optical receiver are electrically connected to the substrate. The support member includes a lower end connected to the substrate and an upper end away from the substrate. The upper end includes a supporting end and a protrusion protruding from the supporting surface. The lens member includes a lens portion and an assembling portion surrounding the lens portion. A thickness of the assembling portion is less than a height of the protrusion relative to the supporting surface. The assembling portion abuts on the supporting surface and a slit is formed between a peripheral side surface of the assembling portion and an inner side surface of the protrusion. An adhesive is distributed in the slit to adhere the lens member to the support member.

### BACKGROUND

1. Technical Field

The present disclosure relates to communication apparatus and, particularly, to an optical connector and a method for assembling the optical connector.

2. Description of Related Art

Optical connectors include a substrate, an optical emitter, an optical receiver, a lens member, and a support member. The optical emitter and the optical receiver are positioned on the substrate, the support member is positioned on the substrate, and the lens member is supported on the support member and optically aligned with the optical emitter and the optical receiver. The lens member is usually fixed to the support member by an adhesive, which may overflow and contaminate optical portions of the lens member during an assembling process.

Therefore, what is needed is an optical connector and a method for assembling the optical connector addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of an optical connector according to one embodiment.

FIG. 2 is a schematic view of a method for assembling the optical connector of FIG. 1.

### DETAILED DESCRIPTION

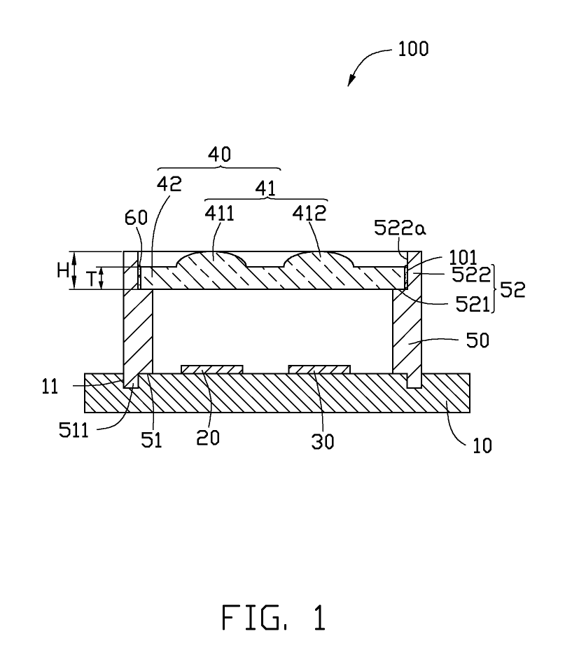

FIG. 1 shows one embodiment of an optical connector 10. The optical connector 10 includes substrate 10, an optical emitter 20, an optical receiver 30, a lens member 40, and a support member 50. The optical emitter 20 and the optical receiver 30 are positioned on and electrically connected to the substrate 10, the support member is positioned on the substrate 10, and the lens member 40 is supported above the optical emitter 10 and the optical receiver 20 by the support member 50.

The substrate 10 provides power and electrical signals to the optical emitter 20 and the optical receiver 30 and also receives electrical signals from the optical emitter 20 and the optical receivers 30.

The optical emitter 20 converts electrical signals (typically carrying information) into corresponding optical signals and emitting the optical signals. The optical receiver 30 is configured for receiving optical signals (typically modulated with information) and converting the optical signals into corresponding electrical signals. In this embodiment, the optical emitter 20 is a laser diode (LD) or a light emitting diode (LED), and the optical receiver 30 is a photodiode (PD).

The lens member 40 transmits optical signals between an optical signal transmitting member (not shown) and the optical emitter 20 or the optical receiver 30. The optical signal transmitting member can be optical fibers or a planar light waveguide. The lens member 40 includes a lens portion 41 (an optical portion) and an assembling portion 42 (a non-optical portion) connected to the lens portion 41. The lens portion 41 includes a first lens 411 corresponding to the light emitter 20 and a second lens 412 corresponding to the light receiver 30. In this embodiment, the first lens 411 and the second lens 412 are convex lenses. The assembling portion 42 surrounds the first lens 411 and the second lens 412. The assembling portion 42 abuts on the support member 50. A thickness of the assembling portion 42 is T.

The support member 50 is configured for supporting lens member 40 and optically aligning the first lens 411 and the second lens 412 with the light emitter 20 and the light receiver 30, respectively. The support member 50 includes a lower end 51 and an upper end 52 opposite to the lower end 51. The lower end 51 is connected to the substrate 10. In this embodiment, the support member 50 includes a flange 511 protruding from the lower end 51, and a groove 11 is defined in the substrate 10 corresponding to the flange 511. The flange 511 is inserted into the groove 11. The upper end 52 includes a supporting surface 521 and a protrusion 522 perpendicular protruding from the supporting surface 521. A height of the protrusion 522 relative to the supporting surface 521 is H. A value of the height H is larger than that of the thickness T. The protrusion 522 includes an inner side surface 522a facing toward the lens member 40. The lens member 40 is supported on the supporting surface 522. A peripheral side surface of the lens member 40 is spaced apart from the inner side surface 522a for a predetermined distance, thus a slit 101 is formed between the peripheral side surface of the lens member 40 and the inner side surface 522a. An adhesive 60 is distributed into the slit 101. The adhesive 60 adheres the lens member 40 to the support member 40.

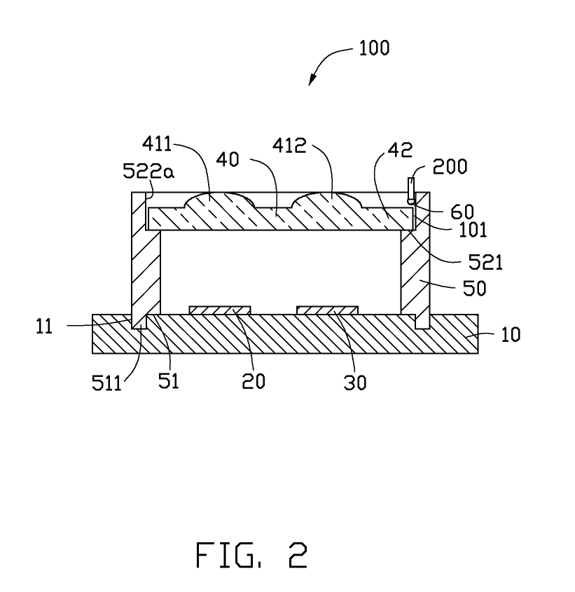

FIG. 2 shows that in assembly, the lens member 40 is fixed to the support member 50 by a method comprising the follow steps.

An optical connector 100 as described above is provided.

The lens member 40 is positioned on the supporting surface 521 of the support member 50.

A dispensing nozzle 200 is provided. The dispensing nozzle 200 contains adhesive 60. Because the surface tension of the adhesive 60, a spherical adhesive drop can be formed at an outlet of the dispensing nozzle 200 when the adhesive 60 flows out of the dispensing nozzle 200. A size of the adhesive drop is slightly larger than that of the outlet of the dispensing nozzle 200.

The adhesive 60 is distributed in the slit 101 by the dispensing nozzle 200. In detail, the dispensing nozzle 200 is positioned adjacent to the inner side surface 522a, adhesive 60 from the dispensing nozzle 200 flows along the inner side surface and fills into the slit 101. In a glue dispensing process, the dispensing nozzle 200 can be moved along a circular path to continuously distribute the adhesive 60 into the slit 101. Alternatively, the optical connector 100 can be positioned on a rotatable base (not shown), the adhesive 60 also can be continuously distributed into the slit 101 by rotating the optical connector 100.

The adhesive 60 in the slit solidifies to adhere the lens member 40 to the support member.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. An optical connector, comprising:
a substrate;
an optical emitter electrically connected to the substrate;
an optical receiver electrically connected to the substrate;
a support member, the support member comprising a lower end connected to the substrate and an upper end away from the substrate, the upper end comprising a supporting end and a protrusion protruding from the supporting surface; and
a lens member supported on the support member, the lens member comprising a lens portion and an assembling portion surrounding the lens portion, a thickness of the assembling portion being less than a height of the protrusion relative to the supporting surface, the assembling portion abutting on the supporting surface and a slit being formed between a peripheral side surface of the assembling portion and an inner side surface of the protrusion, an adhesive being distributed in the slit to adhere the lens member to the support member.

2. The optical connector of claim 1, wherein the optical emitter is a laser diode, and the optical receiver is a photodiode.

3. The optical connector of claim 1, wherein the lens portion comprises a first lens corresponding to the optical emitter and a second lens corresponding to the optical receiver, the first lens and the second lens are optically aligned with the optical emitter and the optical receiver, respectively.

4. The optical connector of claim 3, wherein the first lens and the second lens are convex lenses.

5. The optical connector of claim 4, wherein the support member comprises a flange protruding from the lower end, the substrate defines a groove corresponding to the flange, and the flange is inserted into the groove.

6. A method for assembling an optical connector, comprising:
providing an optical connector, the optical connector comprising a substrate, an optical emitter electrically connected to the substrate, an optical receiver electrically connected to the substrate, a support member, and a lens member, the support member comprising a lower end connected to the substrate and an upper end away from the substrate, the upper end comprising a supporting end and a protrusion protruding from the supporting surface; the lens member comprising a lens portion and an assembling portion surrounding the lens portion, a thickness of the assembling portion being less than a height of the protrusion relative to the supporting surface;
positioning the lens member on the support member, the assembling portion abutting on the supporting surface and a slit being formed between a peripheral side surface of the assembling portion and an inner side surface of the protrusion;
providing a dispensing nozzle, the dispensing nozzle containing adhesive therein;
distributing the adhesive in the slit by the dispensing nozzle;
solidifying the adhesive in the slit solidified to adhere the lens member to the support member.

7. The method of claim 6, wherein the process of distributing the adhesive in the slit comprises:
positioning the dispensing nozzle adjacent to an inner side surface of the protrusion to make the adhesive from the dispensing nozzle flow along the inner side surface and fill into the slit.

8. The method of claim 7, wherein the process of distributing the adhesive in the slit comprises:
moving the dispensing nozzle along a circular path relative to the support member to continuously distribute the adhesive into the slit.
